(19) United States
(12) Patent Application Publication
(10) Pub. No.: US 2022/0156977 A1
(43) Pub. Date: May 19, 2022

(54) CALIBRATION APPARATUS, CALIBRATION METHOD, AND NON-TRANSITORY COMPUTER READABLE MEDIUM STORING PROGRAM

(71) Applicant: Nec Corporation, Minato-ku, Tokyo (JP)

(72) Inventors: Gaku NAKANO, Tokyo (JP); Itaru KITAHARA, Ibaraki (JP)

(73) Assignee: NEC Corporation, Minato-ku, Tokyo (JP)

(21) Appl. No.: 17/439,517

(22) PCT Filed: Mar. 26, 2019
(86) PCT No.: PCT/JP2019/012704

§ 371 Date: Sep. 15, 2021

(51) Int. Cl. G06T 7/80; G06T 7/73; G06T 3/00; G06V 40/16

(52) U.S. Cl. CPC G06T 7/85; G06T 7/73; G06T 3/005; G06T 2207/30201; G06V 40/172; G06T 2207/10021; G06V 40/168

(57) ABSTRACT

In a calibration apparatus (10), an acquisition unit (11) acquires a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person. A camera parameter calculation unit (12) calculates camera parameters of the plurality of cameras using the plurality of positions in the image plane acquired by the acquisition unit (11) as image feature points.

### TECHNICAL FIELD

The present disclosure relates to a calibration apparatus, a calibration method, and a non-transitory computer readable medium storing a program.

### BACKGROUND ART

In order to perform a three-dimensional image analysis using a multi-viewpoint camera system composed of a plurality of cameras, it is necessary to clarify optical characteristics of the cameras and the positional relationship between the cameras. The optical characteristics are parameters unique to each camera, for example, a focal length, lens distortion, optical center coordinates, etc., and are collectively referred to as “internal parameters”. The internal parameters are invariant unless a zoom value is changed or a lens of the camera is replaced with a different lens. The parameters representing the positional relationship between the cameras refer to a rotation matrix and a translation vector and are referred to as “external parameters”. The external parameters are invariant as long as the camera is not moved relative to an origin of three-dimensional coordinates. If these internal and external parameters are known, size and length of a subject in an image can be converted into a physical distance (e.g., meters), and a three-dimensional shape of the subject can be restored. Calculating one or both of these internal and external parameters is referred to as “camera calibration”. Also, one of the internal parameters and the external parameters may be simply referred to as “camera parameters” or both of them may be simply referred to as “camera parameters” without distinguishing between the internal parameters and the external parameters.

Various techniques for the camera calibration have been proposed (e.g., Patent Literature 1). In the camera calibration technique disclosed in Patent Literature 1, a plurality of feature points of a subject's (a person's) face are extracted in a first frame image and a second frame image photographed by a first camera and a second camera, respectively, and external parameters are calculated using the plurality of extracted feature points of the subject's face.

### CITATION LIST

### Patent Literature

Patent Literature 1: Japanese Unexamined Patent Application Publication No. 2016-149678

### SUMMARY OF INVENTION

### Technical Problem

However, in the technique disclosed in Patent Literature 1, there is a possibility that the face may not appear at all in the photographed image depending on an orientation of the subject (the person), and in this case, there is a possibility that the camera calibration may not be executed with high accuracy.

An object of the present disclosure is to provide a calibration apparatus, a calibration method, and a non-transitory computer readable medium storing a program which can maintain accuracy of camera calibration regardless of an orientation of a person in a photographed image.

### Solution to Problem

A first example aspect is a calibration apparatus including:

an acquisition unit configured to acquire a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person; and

a camera parameter calculation unit configured to calculate camera parameters of the plurality of cameras using the plurality of acquired positions in the image plane as image feature points.

A second example aspect is a calibration method including:

acquiring a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person; and

calculating camera parameters of the plurality of cameras using the plurality of acquired positions in the image plane as image feature points.

A third example aspect is a non-transitory computer readable medium storing a program causing a calibration apparatus to execute processing of:

acquiring a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person; and

calculating camera parameters of the plurality of cameras using the plurality of acquired positions in the image plane as image feature points.

### Advantageous Effects of Invention

According to the present disclosure, it is possible to provide a calibration apparatus, a calibration method, and a non-transitory computer readable medium storing a program which can maintain accuracy of camera calibration regardless of an orientation of a person in a photographed image.

### BRIEF DESCRIPTION OF DRAWINGS

FIG. 1 is a block diagram showing an example of a calibration apparatus according to a first example embodiment;

FIG. 2 is a block diagram showing an example of a calibration apparatus according to the second example embodiment;

FIG. 3 is a flowchart showing an example of a processing operation of the calibration apparatus according to the second example embodiment;

FIG. 4 is a diagram for explaining an example of the processing operation of the calibration apparatus according to the second example embodiment;

FIG. 5 is a diagram for explaining an example of the processing operation of the calibration apparatus according to the second example embodiment;

FIG. 6 is a diagram for explaining an example of the processing operation of the calibration apparatus according to the second example embodiment;

FIG. 7 is a diagram for explaining an example of the processing operation of the calibration apparatus according to the second example embodiment; and

FIG. 8 shows an example of a hardware configuration of the calibration apparatus.

### DESCRIPTION OF EMBODIMENTS

Example embodiments will be described below with reference to the drawings. In the example embodiments, the same or equivalent elements are denoted by the same reference signs, and repeated description is omitted.

### First Example Embodiment

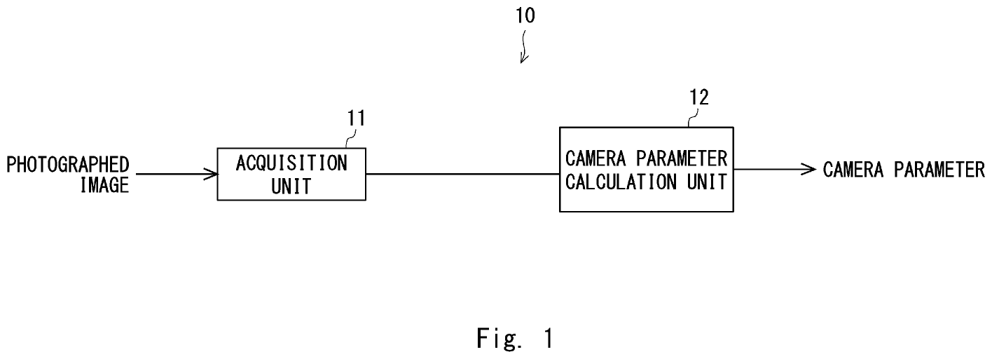

FIG. 1 is a block diagram showing an example of a calibration apparatus according to a first example embodiment. In FIG. 1, a calibration apparatus 10 includes an acquisition unit 11 and a camera parameter calculation unit 12.

The acquisition unit 11 acquires a plurality of positions in an image plane respectively corresponding to a plurality of body region points distributed over a whole body of a person in each of a plurality of photographed images obtained by photographing a common photographing area by a plurality of cameras (not shown) at the same time arranged at positions different from each other and including images of the same person.

For example, when the plurality of photographed images are input, the acquisition unit 11 detects the plurality of body region points distributed over the whole body of the person in each of the plurality of photographed images, and detects the plurality of positions (coordinates) in the image plane respectively corresponding to the detected plurality of body region points. The plurality of body region points may be, for example, a part of a group of body region points used in the “OpenPose” developed at Carnegie Mellon University (CMU). For example, the plurality of body region points may be a plurality of joint points distributed over the whole body of the person.

The camera parameter calculation unit 12 calculates camera parameters of the plurality of cameras (not shown) using the plurality of positions in the image plane acquired by the acquisition unit 11 as image feature points.

According to the configuration of the calibration apparatus 10 described above, since the camera parameters can be calculated using the positions in the image plane of the plurality of body region points distributed over the whole body of the person as the feature points, the accuracy of the camera calibration can be maintained irrespective of an orientation of the person in the photographed image, i.e., regardless of a relative orientation of the person to the plurality of cameras (not shown).

### Second Example Embodiment

A second example embodiment relates to an example embodiment in which images of a plurality of persons (person images) are included in a photographed image.

### <Configuration Example of Calibration Apparatus>

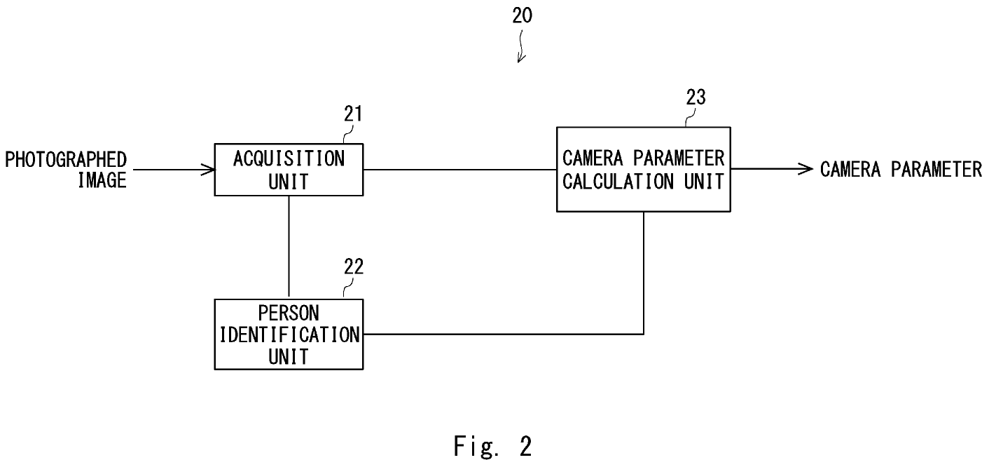

FIG. 2 is a block diagram showing an example of a calibration apparatus according to the second example embodiment. In FIG. 2, a calibration apparatus 20 includes an acquisition unit 21, a person identification unit 22, and a camera parameter calculation unit 23.

Similarly to the acquisition unit 11 according to the first example embodiment, the acquisition unit 21 receives a plurality of photographed images including images of the same person, which are obtained by photographing a common photographing area by a plurality of cameras (not shown) at the same time arranged at positions different from each other. As described above, the plurality of photographed images include a plurality of person images of the same persons. For example, the plurality of cameras (not shown) are arranged at different positions around an intersection, and the common photographing area at the intersection is photographed from different angles, thereby obtaining such plurality of photographed images.

The acquisition unit 21 detects the person image corresponding to each person in each photographed image and assigns a unique “person image identifier (person ID)” to each detected person image. The “person image identifier (person ID)” includes, for example, information of an identifier (i.e., an identifier (a camera ID) of the camera used for capturing the photographed image) in order to distinguish the photographed images. Along with this processing, the acquisition unit 21 detects a plurality of positions in an image plane respectively corresponding to the plurality of body region points including a “reference point” for each detected person image. That is, the acquisition unit 21 assigns different person image identifiers to the plurality of person images if the photographed images in which the person images are detected are different, even if the plurality of person images are of the same person. Then, the acquisition unit 21 outputs, to the person identification unit 22 and the camera parameter calculation unit 23, the person image identifier of each person image and the plurality of positions in the image plane respectively corresponding to the plurality of body region points included in the person image in association with each other. Hereinafter, the “person image identifier of each person image and the plurality of positions in the image plane respectively corresponding to the plurality of body region points included in the person image, which are associated with each other” may be collectively referred to as a “person image unit group information unit”.

The person identification unit 22 specifies a plurality of person images corresponding to each of the same persons in the plurality of photographed images based on a plurality of the “person image unit group information units” received from the acquisition unit 21. For example, the person identification unit 22 calculates a plane projection transformation matrix for a plurality of image planes respectively corresponding to the plurality of photographed images based on the plurality of positions in the image plane respectively corresponding to the plurality of “reference points” of the plurality of the “person image unit group information units”. Then, the person identification unit 22 specifies the plurality of person images corresponding to each of the same persons in the plurality of photographed images based on “geometric consistency” between the calculated plane projection transformation matrix and the plurality of positions in the image plane respectively corresponding to the plurality of “reference points”.

More specifically, the person identification unit 22 specifies the plurality of person images corresponding to each of the same persons in the plurality of photographed images based on the “geometric consistency”, for example, as follows. In order to simplify the description, the plurality of cameras (not shown) are referred to as a first camera and a second camera, and the plurality of photographed images are referred to as a first photographed image and a second photographed image. The person identification unit 22 sequentially selects “corresponding point pairs” from among the plurality of reference points included in the first photographed image and the second photographed image, each “corresponding point pair” including the reference point in the first photographed image and the reference point in the second photographed image. Next, the person identification unit 22 calculates the plane projection transformation matrix for the selected “corresponding point pairs”. When the difference between the “converted reference point” obtained by converting the reference point in the first photographed image which is not included in the corresponding point pairs used for calculating the calculated plane projection transformation matrix using the calculated plane projection transformation matrix and the reference point in the second photographed image corresponding to the converted reference point is less than or equal to a threshold, the person identification unit 22 specifies the plurality of person images corresponding to the reference points of the “corresponding point pairs” used for calculating the calculated plane projection transformation matrix as the person images of the same person. The specification of the plurality of person images corresponding to each of the same persons based on the “geometric consistency” will be described later in detail using a specific example.

Then, the person identification unit 22 groups the plurality of person image identifiers respectively corresponding to the plurality of person images corresponding to each of the specified same person as a “same person identifier group”. Then, the person identification unit 22 outputs the identifiers of the “same person identifier group” and the plurality of person image identifiers included in the “same person identifier group” collectively to the camera parameter calculation unit 23. That is, the identifier of the same person identifier group is associated with each person image identifier.

The camera parameter calculation unit 23 calculates a camera parameter based on the plurality of positions in the image plane corresponding to the same body region point in the plurality of “person image unit group information units” including the person image identifiers belonging to the same person identifier group. In other words, the camera parameter calculation unit 23 calculates the camera parameter based on the plurality of positions in the image plane where the combination of the same person identifier group to which the corresponding person image identifier belongs and the corresponding body region point matches. That is, the camera parameter calculation unit 23 calculates the camera parameters of all the cameras by solving the Structure from Motion (SfM) problem (i.e., multi-view geometry problems) using the positions in the image plane of all the body region points included in the plurality of “person image unit group information units” including the person image identifiers belonging to the same person identifier group as the image feature points.

### <Operation Example of Calibration Apparatus>

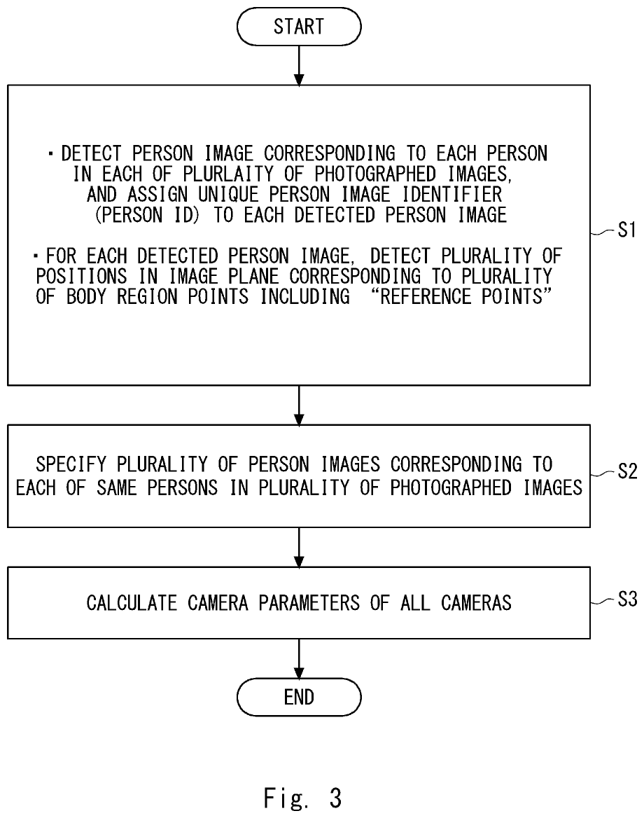

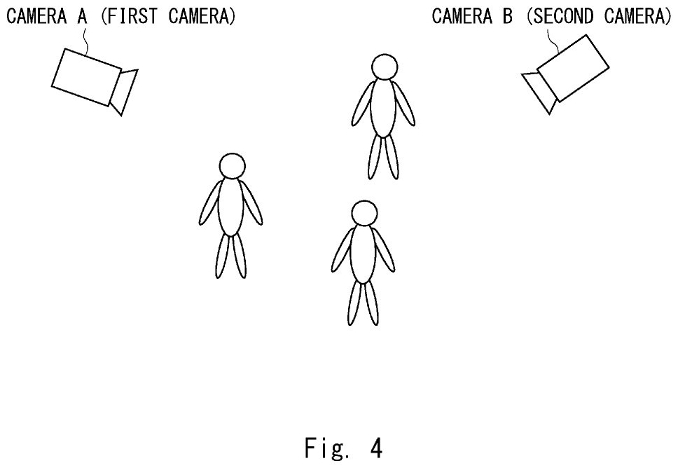

An example of a processing operation in the calibration apparatus 20 having the above-described configuration will be described. FIG. 3 is a flowchart showing an example of a processing operation of the calibration apparatus according to the second example embodiment. FIGS. 4 to 7 are diagrams for explaining an example of the processing operation of the calibration apparatus according to the second example embodiment.

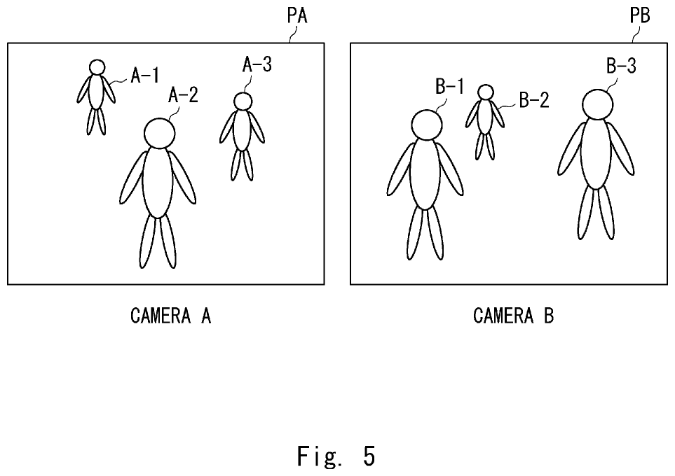

First, in the state shown in FIG. 4, the common photographing area is photographed at the same time by a camera A (the first camera) and a camera B (the second camera). In the state shown in FIG. 4, three persons are present in the photographing area, and the photographed images captured by the cameras A and B include the person images of the three persons as shown in FIG. 5.

When photographed images PA and PB are input to the calibration apparatus 20, the processing flow of FIG. 3 starts.

The acquisition unit 21 detects the person image corresponding to each person in each of the photographed images PA and PB, and assigns a unique “person image identifier (person ID)” to each detected person image (Step S1). As shown in FIG. 5, in the photographed image PA, three person images are detected, and person image identifiers A-1, A-2, and A-3 are assigned to them, respectively. In the photographed image PB, three person images are detected, and the person image identifiers B-1, B-2, and B-3 are assigned respectively. As described above, the person image identifiers include identifiers A and B of the cameras.

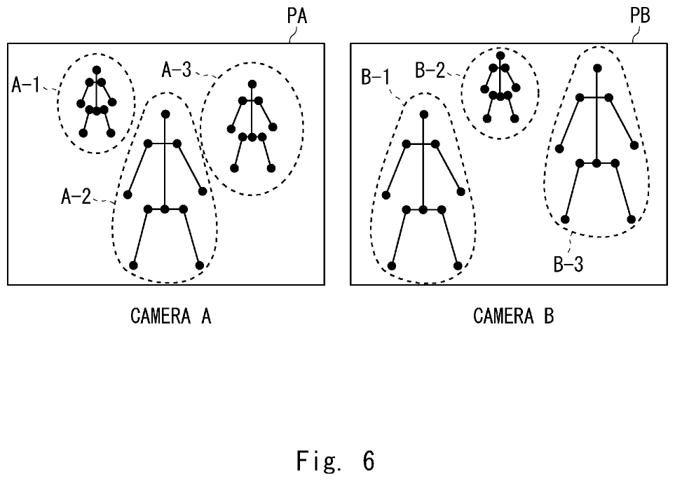

For each detected person image, the acquisition unit 21 detects the plurality of positions in the image plane corresponding to the plurality of body region points including the “reference points” (Step S1). As shown in FIG. 6, the processing in Step S1 forms the “person image unit group information unit” which is the “person image identifier of each person image and the plurality of positions in the image plane respectively corresponding to the plurality of body region points included in the person image, which are associated with each other”. Here, although the plurality of body region points are distributed over the whole body of the person as described above, it is possible to freely define the degree of granularity at which the body region points are detected. For example, in detection of a hand, only a back of the hand may be a target of the detection, or a part of the hand up to the third joint of each finger may be the target of the detection. Further, as described later, the “reference point” preferably includes one or both of a body region point (e.g., a joint point of a right ankle) included in a right foot part and a body region point (e.g., a joint point of a left ankle) included in a left foot part of the person. In the example of FIG. 6, ten positions in the image plane respectively corresponding to ten body region points are detected for each person image.

Next, the person identification unit 22 specifies the plurality of person images corresponding to each of the same persons in the plurality of photographed images based on the plurality of “person image unit group information units” acquired by the acquisition unit 21 (Step S2).

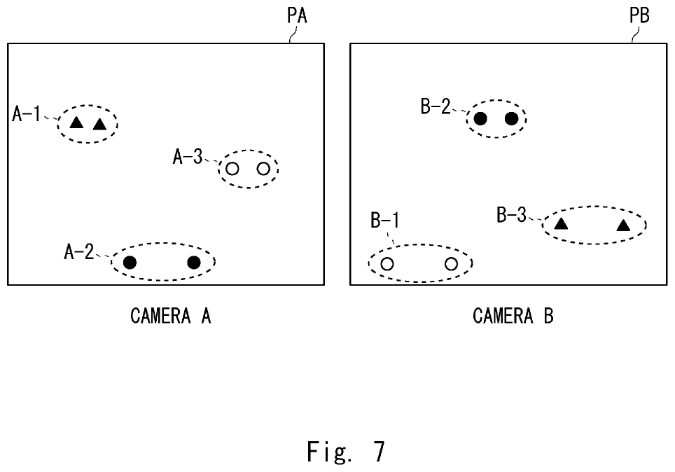

For example, as shown in FIG. 7, the person identification unit 22 uses the plurality of “reference points” in the plurality of “person image unit group information units” to specify the plurality of person images corresponding to each of the same persons in the plurality of photographed images. Here, as shown in FIG. 7, each reference point includes both the body region point included in the right foot part of the person and the body region point included in the left foot part of the person. Since the reference point includes the body region point included in the foot part, robust person identification can be performed. This is because the body region points included in the foot parts regardless of the height of the person is always present close to a ground surface or a floor surface, so that a search range can be limited by regarding the body region point included in the foot part as the image feature point on a plane. That is, each reference point is preferably a body region point (e.g., ankle, heel, toe, or instep of foot) closest to the ground. Hereinafter, the position in the image plane of the body region point included in the right foot part and the position in the image plane of the body region point included in the left foot part in each person image unit group information unit may be collectively referred to as a “class”.

For example, the person identification unit 22 randomly selects two class pairs (i.e., “corresponding point pairs”) between the classes A-1, A-2, and A-3 and the classes B-1, B-2, and B-3. The entirety of class pairs selected here (i.e., in this case, the entirety of two class pairs) may be referred to as a “class set (corresponding point set)”. For example, the class A-1 and class B-1 are defined as a first pair, and class A-2 and class B-2 are defined as a second pair. Then, the person identification unit 22 calculates the plane projection transformation matrix using the position in the image plane of the class A-1 and the position in the image plane of the class B-1 in the first pair as the corresponding points, and the position in the image plane of the class A-2 and the position in the image plane of the class B-2 in the second pair as the corresponding points. Here, the plane projection transformation matrix is a matrix defined by three rows and three columns that describe coordinate transformation of points on a plane when the plane is observed from different angles. The plane projection transformation matrix is also referred to as a homography matrix or H-matrix.

Then, the person identification unit 22 evaluates whether the correspondence between the first pair and the second pair is correct or not using the remaining class A-3 and class B-3 which are not selected as the class pair. That is, the person identification unit 22 calculates the converted position in the image plane by applying the calculated plane projection transformation matrix to the position in the image plane of the class A-3, and determines whether the calculated converted position in the image plane matches the position in the image plane of the class B-3. When they match, it is determined that the correspondence between the first pair and the second pair is correct, and the person image corresponding to the class A-1 and the person image corresponding to the class B-1 are the person images of the same person, and the person image corresponding to the class A-2 and the person image corresponding to the class B-2 are also the person images of the same person. On the other hand, if they do not match, it is determined that the correspondence between the first pair and the second pair is not correct. A class pair may be randomly selected or a class pair which is not yet selected may be selected, and then the above processing may be repeated. Here, “match” means that an error of the converted position in the image plane is less than or equal to a predetermined threshold. This evaluation of the error of the converted position in the image plane is referred to as “verification of geometric consistency”. Although the method based on the random selection has been described above, a method called Iterative Closest Point or Consensus Set Maximization may be used. In FIG. 7, the same symbols indicate that the class A-1 and the class B-3 correspond to the same person, the class A-2 and the class B-2 correspond to the same person, and the class A-3 and the class B-1 correspond to the same person.

Returning to the description of FIG. 3, the camera parameter calculation unit 23 calculates the camera parameters of all the cameras by solving the Structure from Motion (SfM) problem (i.e., multi-view geometry problems) using the positions in the image plane of all the body region points included in the plurality of “person image unit group information units” after the person identification as the image feature points (Step S3).

As described above, according to the second example embodiment, in the calibration apparatus 20, the person identification unit 22 calculates the plane projection transformation matrix for the plurality of image planes respectively corresponding to the plurality of photographed images, based on the plurality of positions in the image plane respectively corresponding to the plurality of “reference points” of the plurality of “person image unit group information units” acquired by the acquisition unit 21. Then, the person identification unit 22 specifies the plurality of person images corresponding to each of the same persons in the plurality of photographed images based on the “geometric consistency” between the calculated plane projection transformation matrix and the plurality of positions in the image plane respectively corresponding to the plurality of “reference points”.

According to the configuration of the calibration apparatus 20, even when a plurality of person images corresponding to a plurality of persons are included in each of the plurality of photographed images, the person images corresponding to the same person can be accurately specified in the plurality of photographed images.

Each reference point includes both the body region point included in the right foot part and the body region point included in the left foot part of the person. This makes it possible to perform robust person identification. This is because the body region points included in the foot parts regardless of the height of the person is always present close to a ground surface or a floor surface, so that a search range can be limited by regarding the body region point included in the foot part as the image feature point on a plane.

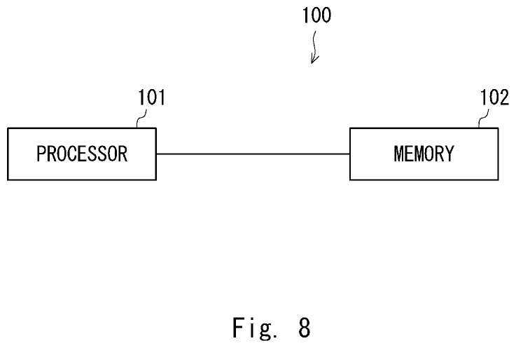

### Other Example Embodiment

<1> When three or more photographed images are input from three or more cameras, the calibration apparatus 20 according to the second example embodiment may divide each of the photographed images into two image pairs and sequentially process the images or may collectively process all the images. The camera parameter calculation unit 23 has a function of integrating calculated parameters of all cameras into one world coordinate system when the images are sequentially processed.

<2> When the SfM problem is solved using only images, the external parameters of the camera are expressed as relative positional relationships, because an absolute length (e.g., meters) is unknown. The calibration apparatuses 10 and 20 according to the first and second example embodiments, respectively, may accept a height of a person present in a screen as an input for conversion into an absolute amount. In this case, the camera parameter calculation units 12 and 23 have a function of performing scaling so that the length (e.g., a length of a joint) between the body region points whose three-dimensional shape has been restored matches the input height value.

<3> In the second example embodiment, the error of the conversion coordinates, i.e., the Euclidean distance, is used as an index for evaluating the geometric consistency, but the present disclosure is not limited to this. For example, algebraic distances or Sampson distances may be used as the index for evaluating the geometric consistency.

<4> FIG. 8 shows an example of a hardware configuration of the camera calibration apparatus. In FIG. 8, a camera calibration apparatus 100 includes a processor 101 and a memory 102. The processor 101 may be, for example, a microprocessor, a Micro Processing Unit (MPU), or a Central Processing Unit (CPU). The processor 101 may include a plurality of processors. The memory 102 is composed of a combination of a volatile memory and a non-volatile memory. The memory 102 may include a storage separated from the processor 101. In this case, the processor 101 may access the memory 102 via an I/O interface (not shown).

The calibration apparatuses 10 and 20 according to the first and second example embodiments, respectively, may have a hardware configuration shown in FIG. 8. The acquisition units 11 and 21, the camera parameter calculation units 12 and 23, and the person identification unit 22 of the calibration apparatuses 10 and 20 according to the first and second example embodiments, respectively, may be implemented by the processor 101 reading and executing a program stored in the memory 102. The program can be stored and provided to the calibration apparatuses 10 and 20 using any type of non-transitory computer readable media. Examples of non-transitory computer readable media include magnetic storage media (such as floppy disks, magnetic tapes, hard disk drives, etc.), optical magnetic storage media (e.g. magneto-optical disks) of tangible storage media. Examples of non-transitory computer readable media further include CD-ROM (Read Only Memory), CD-R, CD-R/W. Examples of non-transitory computer readable media further include semiconductor memories. Semiconductor memories (such as mask ROM, PROM (Programmable ROM), EPROM (Erasable PROM), flash ROM, RAM (Random Access Memory), etc.). The program may be provided to the calibration apparatuses 10 and 20 using any type of transitory computer readable media. Examples of transitory computer readable media include electric signals, optical signals, and electromagnetic waves. Transitory computer readable media can provide the program to the calibration apparatuses 10 and 20 via a wired communication line (e.g. electric wires, and optical fibers) or a wireless communication line.

### REFERENCE SIGNS LIST

10 CALIBRATION APPARATUS
11 ACQUISITION UNIT
12 CAMERA PARAMETER CALCULATION UNIT
20 CALIBRATION APPARATUS
21 ACQUISITION UNIT
22 PERSON IDENTIFICATION UNIT
23 CAMERA PARAMETER CALCULATION UNIT

What is claimed is:

1. A calibration apparatus comprising:
hardware including at least one processor and at least one memory;
an acquisition unit implemented at least by the hardware and that acquires a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person; and
a camera parameter calculation unit implemented at least by the hardware and that calculates camera parameters of the plurality of cameras using the plurality of acquired positions in the image plane as image feature points.

2. The calibration apparatus according to claim 1, wherein
each of the photographed images includes a plurality of person images of the same persons,
the acquisition unit is configured to detect a person image corresponding to each person in each of the photographed images, and detect, for each detected person image, the plurality of positions in the image plane respectively corresponding to the plurality of body region points including a reference point, and
the calibration apparatus further comprises a person identification unit implemented at least by the hardware and that specifies a plurality of the person images corresponding to each of the same persons in the plurality of photographed images based on the plurality of positions in the image plane respectively corresponding to a plurality of the reference points detected by the acquisition unit.

3. The calibration apparatus according to claim 2, wherein
the person identification unit is configured to calculate a plane projection transformation matrix for a plurality of image planes respectively corresponding to the plurality of photographed images based on the plurality of positions in the image plane respectively corresponding to the plurality of reference points detected by the acquisition unit, and specify the plurality of person images corresponding to each of the same persons in the plurality of photographed images based on geometric consistency between the calculated plane projection transformation matrix and the plurality of positions in the image plane respectively corresponding to the plurality of reference points.

4. The calibration apparatus according to claim 3, wherein
the plurality of cameras are a first camera and a second camera,
the plurality of photographed images are a first photographed image and a second photographed image,
the person identification unit is configured to sequentially select, from among the plurality of reference points included in the first photographed image and the second photographed image, a corresponding point set including the reference point in the first photographed image and the reference point in the second photographed image, and calculate the plane projection transformation matrix for the selected corresponding point set, and specify, as the person image of the same person, the plurality of person images corresponding to the reference points in the corresponding point set used in the calculation of the plane projection transformation matrix, when a difference between a converted reference point obtained by converting the reference point in the first photographed image not included in the corresponding point set used in the calculation of the calculated plane projection transformation matrix by the calculated plane projection transformation matrix and the reference point in the second photographed image corresponding to the converted reference point is less than or equal to a threshold.

5. The calibration apparatus according to claim 2, wherein
the acquisition unit is configured to assign a unique person image identifier to each of the detected person images,
the person identification unit is configured to group a plurality of person image identifiers respectively corresponding to the plurality of person images corresponding to each of the specified persons as a same person identifier group, and
the camera parameter calculation unit is configured to calculate the camera parameter based on the plurality of positions in the image plane where a combination of the same person identifier group to which the corresponding person image identifier belongs and the corresponding body region point matches.

6. The calibration apparatus according to claim 2, wherein
the reference point includes a body region point included in a right foot part of the person and a body region point included in a left foot part of the person.

7. A calibration method comprising:
acquiring a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person; and
calculating camera parameters of the plurality of cameras using the plurality of acquired positions in the image plane as image feature points.

8. A non-transitory computer readable medium storing a program causing a calibration apparatus to execute processing of:
acquiring a plurality of positions in an image plane respectively corresponding to a plurality of body region points distributed over a whole body of a person in each of a plurality of photographed images obtained by photographing a common photographing area by a plurality of cameras at the same time arranged at positions different from each other and including images of a same person; and
calculating camera parameters of the plurality of cameras using the plurality of acquired positions in the image plane as image feature points.
